(19) United States
(12) Patent Application Publication
(10) Pub. No.: US 2019/0384426 A1
(43) Pub. Date: Dec. 19, 2019

(54) TOUCH MODULE

(71) Applicant: Primax Electronics Ltd., Taipei (TW)

(72) Inventor: Tai-Sou Huang, Taipei (TW)

(21) Appl. No.: 16/110,486

(22) Filed: Aug. 23, 2018

(30) Foreign Application Priority Data
Jun. 15, 2018 (TW) 107120718

(51) Int. Cl. G06F 3/0354

(52) U.S. Cl. CPC G06F 3/03547

(57) ABSTRACT

A control module includes a frame structure, a touchpad assembly and a hinge structure. The touchpad assembly is located over the frame structure. The hinge structure is arranged between the frame structure and the touchpad assembly. The hinge structure includes an elastic plate and a supporting element. An end of the elastic plate is connected with the touchpad assembly. The supporting element is disposed on frame structure and connected with the elastic plate. Due to the elastic plate, the touchpad assembly is swung is swung along a fixed direction. While the touchpad assembly is pressed down, the end of the elastic plate is correspondingly swung. Consequently, the touchpad assembly is swung stably, and the touch module is operated stably.

### FIELD OF THE INVENTION

The present invention relates to an input device, and more particularly to a touch module that is installed on a computer.

### BACKGROUND OF THE INVENTION

The widely-used peripheral input device of a computer system includes for example a mouse device, a keyboard device, a trackball device, or the like. With the progress of the times, a touch module is introduced into the market. By directly using the user's fingers to operate the touch module, the computer system can be correspondingly controlled. The applications of the touch module are very extensive. In the early stage, a notebook computer is equipped with a touch module. By operating the touch mouse, the movement of a cursor may be controlled or a corresponding icon of a user interface may be clicked without the need of using a mouse to operate the notebook computer. In an advantage of the touch module, the touch module can be intuitively operated by the user and thus various commands can be correspondingly executed.

FIG. 1 schematically illustrates a conventional notebook computer with a touch module. The touch module 1 is installed on a computer casing 21 of a notebook computer 2. Moreover, the touch module 1 is partially exposed outside the computer casing 21. When the touch module 1 is touched by the user's finger, the notebook computer 2 is correspondingly controlled. For example, when the user's finger is placed on the touch module 1 and moved on the touch module 1, a cursor 23 shown on a display screen 22 of the notebook computer 2 is correspondingly moved. Alternatively, the user may press down the touch module 1 to execute a button function of the notebook computer 2. In other words, the touch module 1 can be used to replace the mouse. Since it is not necessary to additionally carry and install the mouse, the use of the touch module is more convenient.

The inner structure of the conventional touch module will be described as follows. FIG. 2 is a schematic cross-sectional side view illustrating the conventional touch module. Please refer to FIGS. 1 and 2. The touch module 1 is installed in the computer casing 21 and partially exposed outside the computer casing 21. The touch module 1 comprises a frame structure 11, a touchpad assembly 12, a supporting metal block 13 and a sponge structure 14. The frame structure 11 is disposed on the computer casing 21. The frame structure 11 comprises a protrusion part 111. The sponge structure 14 is attached on an edge of the frame structure 11 through an adhesive. In addition, the supporting metal block 13 is attached on the sponge structure 14 through an adhesive. The touchpad assembly 12 is located over the frame structure 11. A first end of the touchpad assembly 12 is connected with the supporting metal block 13 through an adhesive. The touchpad assembly 12 comprises a covering plate 121, a circuit board 122 and a switch element 123. A first end of the circuit board 122 is connected with the supporting metal block 13. The switch element 123 is disposed on a bottom surface of the circuit board 122 and located at a second end of the circuit board 122. The covering plate 121 is disposed on the circuit board 122 and exposed outside the computer casing 21.

FIG. 3 is a schematic cross-sectional side view illustrating the conventional touch module, in which the touchpad assembly is pressed down. Please refer to FIGS. 1, 2 and 3. When the user's finger is placed on the touchpad assembly 12 to press down the touchpad assembly, a second end of the touchpad assembly 12 (e.g., the position corresponding to the switch element 123) is swung downwardly relative to the computer casing 21 by using the supporting metal block 13 and the sponge structure 14 as fulcrums. As the touchpad assembly 12 is pressed down, the sponge structure 14 is compressed in response to the pressing force. Consequently, the touchpad assembly 12 is swung downwardly. While the touchpad assembly 12 is swung downwardly, the switch element 123 on the circuit board 122 and the protrusion part 111 of the frame structure 11 are contacted with each other. Meanwhile, the switch element 123 is triggered to generate a corresponding key signal to the notebook computer 2. According to the key signal, the notebook computer 2 executes a corresponding command. When the user's finger is not placed on the touchpad assembly 12, the touchpad assembly 12 is swung upwardly and returned to its original position in response to the internal elastic force of the switch element 123 and the elastic restoring force of the sponge structure 14. Due to the above operations, the conventional touch module 1 can achieve the button function to replace the mouse.

In the conventional touch module 1, the touchpad assembly 12 is fixed on the supporting metal block 13. The sponge structure 14 made of a soft material is located under the supporting metal block 13. While the touchpad assembly 12 is pressed down, the sponge structure 14 is compressed and thus the touchpad assembly 12 is correspondingly swung. However, the conventional touch module 1 still has some drawbacks. For example, the sponge structure 14 is irregularly compressed in various directions. Since the touchpad assembly 12 is swung unstably, the tactile feel of the conventional touch module 1 is impaired.

Therefore, there is a need of providing a touch module that is capable of being stably operated.

### SUMMARY OF THE INVENTION

An object of the present invention provides a touch module that is capable of being stably operated.

In accordance with an aspect of the present invention, there is provided a touch module. The touch module is installed on a computer casing. The control module includes a frame structure, a touchpad assembly and a hinge structure. The touchpad assembly is located over the frame structure and partially exposed outside the upper casing. While the touchpad assembly is pressed down and swung relative to the computer casing, the touchpad assembly is contacted with the frame structure, so that a corresponding key signal is generated. The hinge structure is arranged between the frame structure and the touchpad assembly. While the touchpad assembly is swung, the hinge structure is subjected to deformation. The hinge structure includes an elastic plate and a supporting element. An end of the elastic plate is connected with the touchpad assembly. The supporting element is disposed on frame structure and connected with the elastic plate to support the elastic plate. While the touchpad assembly is pressed down, the end of the elastic plate is correspondingly swung, so that the touchpad assembly is swung.

In an embodiment, the elastic plate includes a main body, at least one extension arm and at least one hollow region. The main body is disposed on the supporting element. The at least one extension arm is externally extended from the main body and connected with the touchpad assembly. As the at least one extension arm is swung, the touchpad assembly is correspondingly swung. The at least one hollow region corresponds to the at least one extension arm. Each of the at least one hollow region is arranged between the corresponding extension arm and the main body to assist in swinging the at least one extension arm.

In an embodiment, while the touchpad assembly is pressed down, the main body is supported by the supporting element, the main body is not swung, the at least one extension arm is swung relative to the main body according to an elasticity of the elastic plate and the at least one hollow structure, and the touchpad assembly is swung relative to the computer casing. Consequently, the touchpad assembly is contacted with the frame body.

From the above descriptions, the touch module of the present invention comprises the hinge structure with the elastic plate. Since the sponge structure is not used, the irregular deformation is not produced. Consequently, while the touchpad assembly is pressed down, the hinge structure is not irregularly rocked. Moreover, due to the hollow regions of the elastic plate, the plural extension arms are permitted to be swung along the fixed direction only. The swinging direction of the plural extension arms is vertical to the installation direction of the plural hollow regions. Since the touchpad assembly is swung along the fixed direction through the elastic plate, the touchpad assembly can be swung stably.

The above objects and advantages of the present invention will become more readily apparent to those ordinarily skilled in the art after reviewing the following detailed description and accompanying drawings, in which:

### BRIEF DESCRIPTION OF THE DRAWINGS

FIG. 1 schematically illustrates a conventional notebook computer with a touch module;

FIG. 2 is a schematic cross-sectional side view illustrating the conventional touch module;

FIG. 3 is a schematic cross-sectional side view illustrating the conventional touch module, in which the touchpad assembly is pressed down;

FIG. 4 is a schematic cross-sectional side view illustrating a touch module according to an embodiment of the present invention;

FIG. 5 is a schematic exploded view illustrating the touch module according to the embodiment of the present invention and taken along a viewpoint;

FIG. 6 is a schematic exploded view illustrating the touch module according to the embodiment of the present invention and taken along another viewpoint; and

FIG. 7 is a schematic cross-sectional side view illustrating the touch module according to the embodiment of the present invention, in which the touchpad assembly is pressed down.

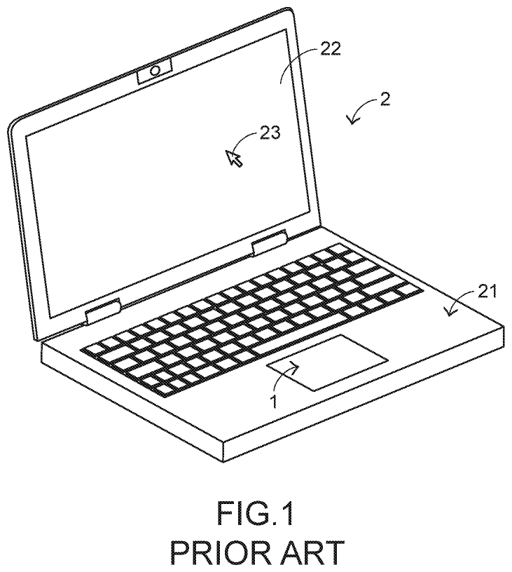

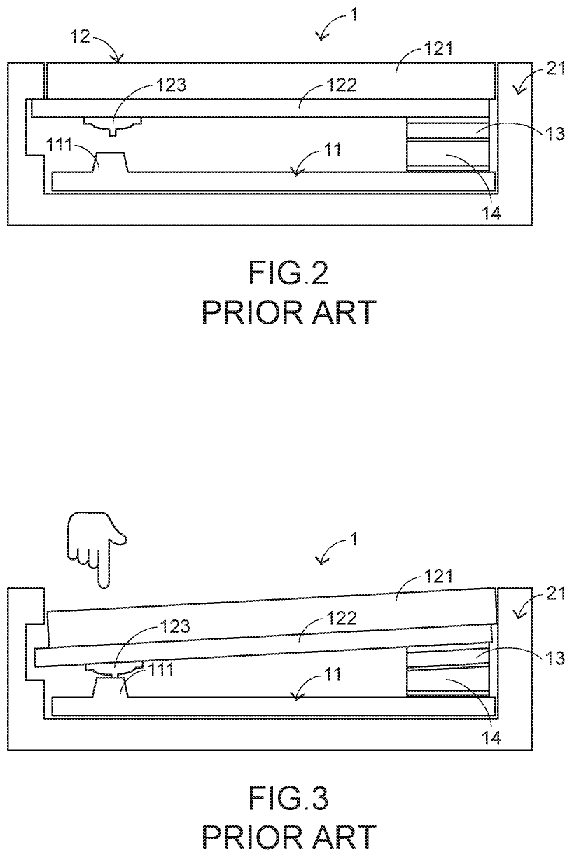

### DETAILED DESCRIPTION OF THE PREFERRED EMBODIMENT

For overcoming the drawbacks of the conventional technologies, the present invention provides a touch module.

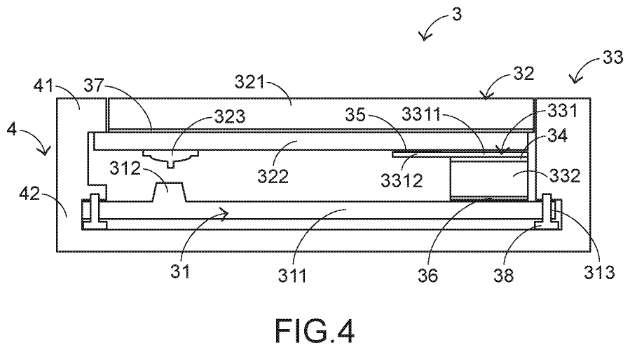

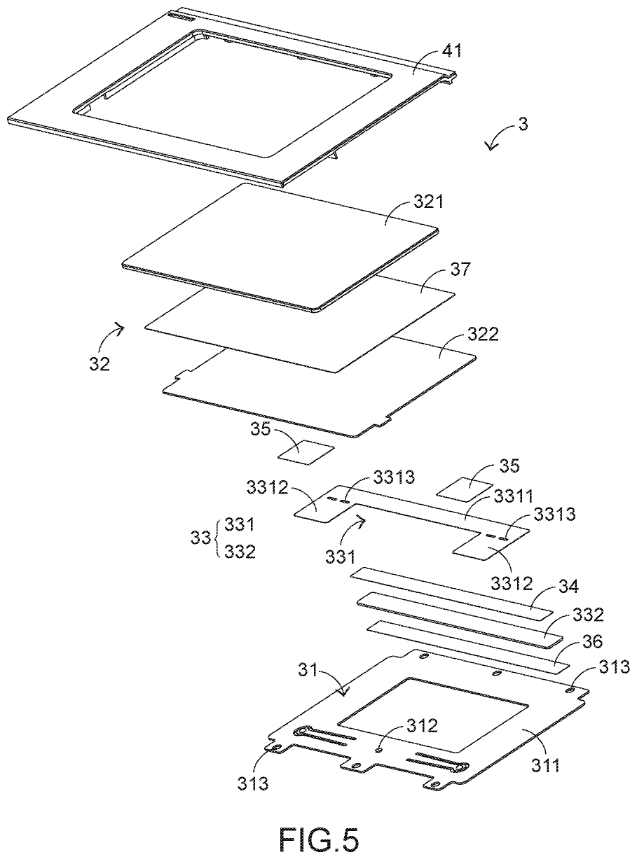

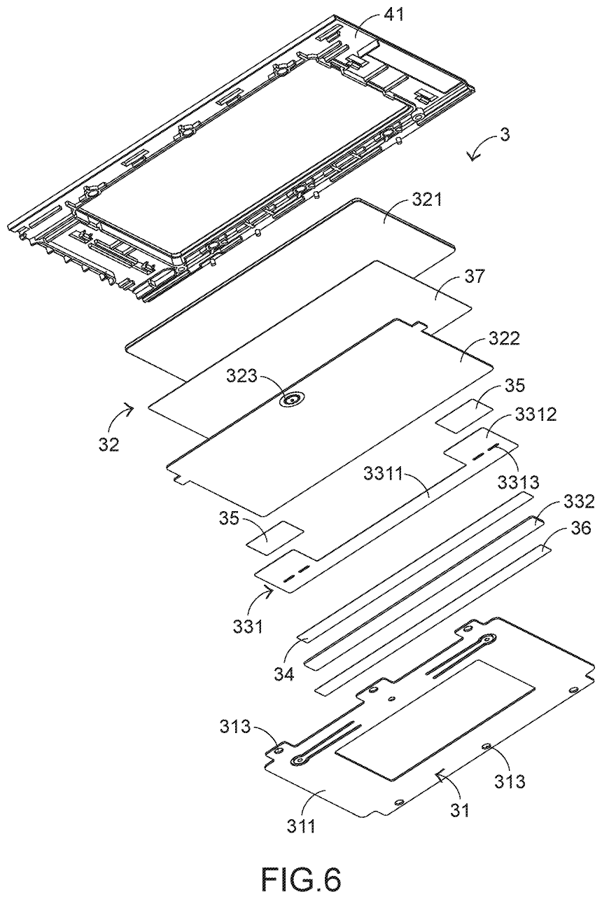

Please refer to FIGS. 4, 5 and 6. FIG. 4 is a schematic cross-sectional side view illustrating a touch module according to an embodiment of the present invention. FIG. 5 is a schematic exploded view illustrating the touch module according to the embodiment of the present invention and taken along a viewpoint. FIG. 6 is a schematic exploded view illustrating the touch module according to the embodiment of the present invention and taken along another viewpoint. The touch module 3 is installed on a computer casing 4 and exposed outside the computer casing 4. In an embodiment, the touch module 3 comprises a frame structure 31, a touchpad assembly 32 and a hinge structure 33. The computer casing 4 comprises an upper casing 41 and a lower casing 42. The touchpad assembly 32 is located over the frame structure 31 and partially exposed outside the upper casing 41. When the touchpad assembly 32 is pressed down and swung relative to the computer casing 4, the touchpad assembly 32 is contacted with the frame structure 31. Consequently, a key signal is correspondingly generated.

The hinge structure 33 is arranged between the frame structure 31 and the touchpad assembly 32. As the touchpad assembly 32 is swung, the hinge structure 33 is subjected to partial deformation. In an embodiment, the hinge structure 33 comprises an elastic plate 331 and a supporting element 332. A first end of the elastic plate 331 is connected with the touchpad assembly 32. The supporting element 332 is disposed on frame structure 31 and connected with the elastic plate 331. The elastic plate 331 is supported by the supporting element 332. When the user's finger is placed on the touchpad assembly 32 to press down the touchpad assembly 32, the first end of the elastic plate 331 is correspondingly swung. Consequently, the touchpad assembly 32 is swung relative to the computer casing 4.

The components of the hinge structure 33 will be described as follows. The elastic plate 331 comprises a main body 3311, plural extension arms 3312 and plural hollow regions 3313. The main body 3311 is disposed on the supporting element 332. The plural extension arms 3312 are externally extended from the main body 3311. As the extension arms 3312 are swung, the elastic plate 331 is subjected to deformation and the touchpad assembly 32 is correspondingly swung. The hollow regions 3313 are aligned with the corresponding extension arms 3312, respectively. Each hollow region 3313 is arranged between the corresponding extension arm 3312 and the main body 3311. In an embodiment, the hollow regions 3313 are through-holes. Because of the hollow regions 3313, the extension arms 3312 are readily bent in response to the external force. While the elastic plate 331 is pressed down, the hollow regions 3313 may assist in swinging the extension arms 3312.

In the hinge structure 33, the main body 3311 of the elastic plate 331 is connected with the supporting element 332 through a first adhesive layer 34. The extension arms 3312 are connected with the touchpad assembly 32 through plural second adhesive layers 35. The supporting element 332 is disposed on the frame structure 31 through a third adhesive layer 36. In this embodiment, the main body 3311 and the extension arms 3312 are integrally formed with the elastic plate 331. Moreover, the main body 3311 and the extension arms 3312 are made of metallic material. The supporting element 332 is also made of metallic material. Moreover, the first adhesive layer 34, the second adhesive layers 35 and the third adhesive layer 36 are made of pressure sensitive adhesive.

Please refer to FIGS. 5 and 6. The touchpad assembly 32 comprises a covering plate 321, a circuit board 322 and a switch element 323. The covering plate 321 is exposed outside the upper casing 41. The circuit board 322 is located under the covering plate 321 and connected with the covering plate 321. The switch element 323 is disposed on a bottom surface of the circuit board 322 and electrically connected with the circuit board 322. While the covering plate 321 is pressed down, the covering plate 321, the circuit board 322 and the switch element 323 are swung relative to the computer casing 4, and the switch element 323 and the frame structure 31 are contacted with each other. Consequently, the switch element 323 is triggered to generate a corresponding key signal. Moreover, the circuit board 322 is connected with the covering plate 321 through a fourth adhesive layer 37. For example, the fourth adhesive layer 37 is made of pressure sensitive adhesive.

The frame structure 31 comprises a frame body 311, a protrusion part 312 and plural positioning holes 313. The protrusion part 312 is disposed on the frame body 311. Moreover, the protrusion part 312 is located under the switch element 323 of the touchpad assembly 32. The plural positioning holes 313 are formed in a periphery region of the frame body 311. After plural fastening elements 38 are penetrated through the corresponding positioning holes 313 and tightened in the lower casing 42 of the computer casing 4, the frame structure 31 is fixed on the computer casing 4. Preferably but not exclusively, the fastening elements 38 are screws, and the protrusion part 312 is integrally formed with the frame body 311. In another embodiment, the protrusion part is disposed on the frame body through an adhering means, an engaging means, an assembling means or any other appropriate coupling means.

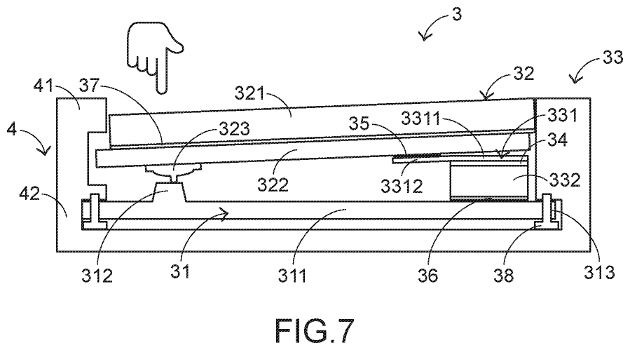

Hereinafter, the operations of the touch module 3 will be described with reference to FIGS. 4, 5, 6 and 7. FIG. 7 is a schematic cross-sectional side view illustrating the touch module according to the embodiment of the present invention, in which the touchpad assembly is pressed down. While the covering plate 321 of the touchpad assembly 32 is touched by the user's finger, the covering plate 321, the circuit board 322 and the switch element 323 are swung downwardly relative to the computer casing 4 by using the supporting element 332 as a fulcrum. Due to the plural extension arms 3312 and the plural hollow regions 3313, the plural extension arms 3312 are swung relative to the main body 3311 along the direction vertical to the plural hollow regions 3313. That is, the elastic plate 331 is subjected to deformation along the fixed direction. While the touchpad assembly 32 is swung downwardly, the switch element 323 on the bottom surface of the circuit board 322 is pushed by the protrusion part 312 of the frame structure 31. Consequently, the switch element 323 is triggered to generate a corresponding key signal. When the user's finger is not placed on the covering plate 321, the touchpad assembly 32 is swung upwardly and returned to its original position in response to the internal elastic force of the switch element 323 and the elastic restoring force of the elastic plate 331.

As mentioned above, the elastic plate 331 comprises the plural extension arms 3312 and the plural hollow regions 3313. When the elastic plate 331 receives a downward pressing force, the plural extension arms 3312 are easily swung relative to main body 3331. The swinging direction of the plural extension arms 3312 is vertical to the installation direction of the plural hollow regions 3313. The installation direction of the plural hollow regions 3313 is the arranging direction of the plural through-holes. Since the touchpad assembly 32 is swung along the fixed direction through the elastic plate 331, the touchpad assembly 32 can be swung stably.

From the above descriptions, the touch module of the present invention comprises the hinge structure with the elastic plate. Since the sponge structure is not used, the irregular deformation is not produced. Consequently, while the touchpad assembly is pressed down, the hinge structure is not irregularly rocked. Moreover, due to the hollow regions of the elastic plate, the plural extension arms are permitted to be swung along the fixed direction only. The swinging direction of the plural extension arms is vertical to the installation direction of the plural hollow regions. Since the touchpad assembly is swung along the fixed direction through the elastic plate, the touchpad assembly can be swung stably. In other words, the touch module of the present invention is capable of solving the drawbacks of the conventional technologies.

While the invention has been described in terms of what is presently considered to be the most practical and preferred embodiments, it is to be understood that the invention needs not be limited to the disclosed embodiments. On the contrary, it is intended to cover various modifications and similar arrangements included within the spirit and scope of the appended claims which are to be accorded with the broadest interpretation so as to encompass all modifications and similar structures.

What is claimed is:

1. A touch module installed on a computer casing, the control module comprising:
a frame structure;
a touchpad assembly located over the frame structure and partially exposed outside the upper casing, wherein while the touchpad assembly is pressed down and swung relative to the computer casing, the touchpad assembly is contacted with the frame structure, so that a corresponding key signal is generated; and
a hinge structure arranged between the frame structure and the touchpad assembly, wherein while the touchpad assembly is swung, the hinge structure is subjected to deformation, wherein the hinge structure comprises:
an elastic plate, wherein an end of the elastic plate is connected with the touchpad assembly; and
a supporting element disposed on frame structure and connected with the elastic plate to support the elastic plate,
wherein while the touchpad assembly is pressed down, the end of the elastic plate is correspondingly swung, so that the touchpad assembly is swung.

2. The touch module according to claim 1, wherein the elastic plate comprises:
a main body disposed on the supporting element;
at least one extension arm externally extended from the main body and connected with the touchpad assembly, wherein while the at least one extension arm is swung, the touchpad assembly is correspondingly swung; and
at least one hollow region corresponding to the at least one extension arm, wherein each of the at least one hollow region is arranged between the corresponding extension arm and the main body to assist in swinging the at least one extension arm.

3. The touch module according to claim 2, wherein the main body and the at least one extension arm are integrally formed with each other, and the main body and the at least one extension arm are made of metallic material.

4. The touch module according to claim 2, wherein while the touchpad assembly is pressed down, the main body is supported by the supporting element, the main body is not swung, the at least one extension arm is swung relative to the main body according to an elasticity of the elastic plate and the at least one hollow structure, and the touchpad assembly is swung relative to the computer casing, so that the touchpad assembly is contacted with the frame body.

5. The touch module according to claim 2, wherein the main body is connected with the supporting element through a first adhesive layer, and the at least one extension arm is connected with the touchpad assembly through at least one second adhesive layer.

6. The touch module according to claim 2, wherein the supporting element is disposed on the frame structure through a third adhesive layer.

7. The touch module according to claim 1, wherein the touchpad assembly comprises:
a covering plate exposed outside the computer casing;
a circuit board located under the covering plate and connected with the covering plate; and
a switch element disposed on a bottom surface of the circuit board and electrically connected with the circuit board, wherein while the covering plate is pressed down, the covering plate, the circuit board and the switch element are swung relative to the computer casing, and the switch element is contacted with the frame structure to generate the key signal.

8. The touch module according to claim 7, wherein the circuit board is connected with the covering plate through a fourth adhesive layer.

9. The touch module according to claim 7, wherein the frame structure comprises:
a frame body; and
a protrusion part disposed on the frame body and located under the switch element, wherein while the covering plate is pressed down, the covering plate, the circuit board and the switch element are swung relative to the computer casing, and the switch element is pushed by the protrusion part, so that the key signal is generated.

10. The touch module according to claim 9, wherein the frame structure further comprises plural positioning holes, which are formed in a periphery region of the frame body, wherein after plural fastening elements are penetrated through the corresponding positioning holes and tightened in the computer casing, the frame structure is fixed on the computer casing.
